(19) United States
(12) Patent Application Publication
(10) Pub. No.: US 2025/0265495 A1
(43) Pub. Date: Aug. 21, 2025

(54) ELECTRONIC DEVICE FOR TRAINING ARTIFICIAL INTELLIGENCE LEARNING MODEL, AND OPERATION METHOD OF THE ELECTRONIC DEVICE

(71) Applicant: SAMSUNG ELECTRONICS CO., LTD., Suwon-si, (KR)

(72) Inventors: Jaehun Jang, Suwon-si (KR); Youngsok Kim, Seoul (KR); Jaeyong Song, Seoul (KR); Jinho Lee, Seoul (KR); Hongsun Jang, Seoul (KR); Jaewon Jung, Seoul (KR); Hongrak Son, Suwon-si (KR)

(73) Assignee: Seoul National University R&DB Foundation, Seoul (KR)

(21) Appl. No.: 18/977,661

(22) Filed: Dec. 11, 2024

(30) Foreign Application Priority Data
Feb. 20, 2024 (KR) 10-2024-0024465
May 16, 2024 (KR) 10-2024-0064141

(51) Int. Cl. G06N 20/00; G06F 13/36

(52) U.S. Cl. CPC G06N 20/00; G06F 13/36; G06F 2213/40

(57) ABSTRACT

An electronic device includes a host including a host memory, a first processor, and a second processor. The first processor updates gradients based on parameters stored in the host memory. The electronic device further includes a computational storage device (CSD) including a storage device storing parameters of an artificial intelligence learning model, gradients, and optimizer states (OSs) and an accelerator configured to transmit and receive the parameters, the gradients, and the OSs to and from the storage device through an inner-path. The electronic device also includes an interconnect configured to connect the host to the CSD and transmit the gradients and the parameters between the host and the CSD. The second processor controls the accelerator to update the OSs and the parameters based on the gradients and the OSs.

### CROSS-REFERENCE TO RELATED APPLICATION(S)

This application is based on and claims priority under 35 U.S.C. § 119 to Korean Patent Application No. 10-2024-0024465, filed on Feb. 20, 2024, and Korean Patent Application No. 10-2024-0064141, filed on May 16, 2024, in the Korean Intellectual Property Office, the disclosures of which are incorporated by reference herein in its entirety.

### BACKGROUND

Recent rapid developments of a large language model (LLM) are being mainly driven by an increase in the number of parameters. Accordingly, a significant memory capacity is desired, and several tens of graphics processing units (GPUs) are desired to meet the capacity. One of the solutions thereto is storage-offload training. In storage-offload training, a host memory and a storage device are used as an extended memory hierarchy. Because the storage device has a lower bandwidth than GPU devices, a storage bandwidth bottleneck may occur.

### SUMMARY

The inventive concept provides addressing of a bandwidth bottleneck of storage-offload training.

In a first general aspect, an electronic device includes: a host including a host memory, a first processor, and a second processor, a computational storage device (CSD) including a storage device storing gradients and optimizer states (OSs) and an accelerator configured to transmit and receive the gradients and the OSs to and from the storage device through an inner-path, and an interconnect configured to connect the host to the CSD and transmit parameters of an artificial intelligence (AI) learning model and the gradients between the host and the CSD. The first processor may be configured to update gradients, based on the parameter of the AI learning model stored in the host memory. The second processor may control the accelerator to update the OSs and the parameters based on the gradients and the OSs.

In a second general aspect, an electronic device including a host including a host memory, a first processor, and a second processor, wherein the first processor is configured to update gradients, based on parameters stored in the host memory, a plurality of CSDs including a storage device storing parameters of an artificial intelligence learning model, gradients, and optimizer states (OSs) and an accelerator configured to transmit and receive the parameters, the gradients, and the OSs to and from the storage device through at least one inner-path, and an interconnect configured to connect the host to the plurality of CSDs and transmit the gradients and the parameters between the host and the plurality of CSDs. The second processor controls the accelerator to update the OSs and the parameters based on the gradients and the OSs.

In a third general aspect, there is provided a CSD including a storage device storing gradients and OSs that are updated based on parameters of an artificial intelligence (AI) learning model, an inner-path that performs direct communication between the storage device and an accelerator, and an accelerator configured to transmit and receive the gradients and the OSs to and from the storage device through the inner path and update the OSs and the parameters based on the gradients and the OSs.

### BRIEF DESCRIPTION OF THE DRAWINGS

FIG. 1 is a block diagram of an example of an electronic device.

FIG. 2 is a block diagram of an example of an electronic device.

FIG. 3 is a block diagram of an example of an update operation of an electronic device.

FIGS. 4A and 4B are diagrams of an example of data transmission of an electronic device.

FIGS. 5A and 5B are block diagrams of an example of a gradient decompression operation of an electronic device.

FIG. 6A is a flowchart of an example of an update operation of an electronic device.

FIG. 6B is a flowchart of an example of an update operation of an electronic device.

FIG. 7 is a flowchart of an example of a data transmission operation of an electronic device.

FIG. 8 is a flowchart of an example of a gradient decompression operation of an electronic device.

FIG. 9 is a block diagram of an example of a Redundant Array of Inexpensive Disk (RAID) structure.

FIG. 10 is a block diagram of an example of an electronic device. FIG. 11 is a block diagram of an example of a computational storage device.

### DETAILED DESCRIPTION

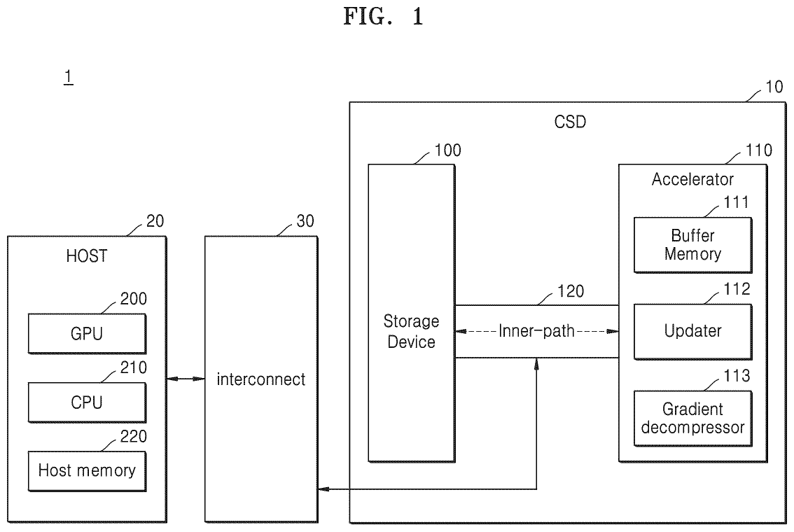

FIG. 1 is a block diagram of an example of an electronic device 1.

Referring to FIG. 1, the electronic device 1 includes a computational storage device (CSD) 10, a host 20, and an interconnect 30.

The CSD 10 may include a storage device 100, an accelerator 110, and an inner-path 120. The storage device 100 may include an embedded universal flash storage (UFS), an embedded multi-media card (eMMC), a solid state drive (SSD), a UFS memory card, a compact flash (CF) card a secure digital (SD) card, a micro-SD card, a hard disk drive (HDD), a mini-SD card, an extreme Digital (xD) card, and a memory stick. However, the storage device 100 is not limited thereto, and may include various other storages.

In some implementations, the interconnect 30 may include a peripheral component interconnect express (PCIe) and a compute express link (CXL). When the interconnect 30 is a PCIe, the inner-path 120 may be a PCIe switch. When the interconnect 30 is a CXL, the inner-path 120 may be a CXL switch. The interconnect 30 and the inner-path 120 may include a variety of interfaces, but implementations are not limited thereto.

The accelerator 110 may refer to a hardware device used in artificial intelligence (AI) learning and may include a plurality of processing elements. For example, the accelerator 110 may include, but is not limited to, a graphics processing unit (GPU), a tensor processing unit (TPU), a field-programmable gate array (FPGA), and an application-specific integrated circuit (ASIC).

The host 20 may include one or more processors. For example, the host 20 may include a GPU 200 and a central processing unit (CPU) 210. The host 20 may include, but is not limited to, a variety of processors. The host 20 may also include a host memory 220. The interconnect 30 enables communication between the host 20 and the CSD 10. For example, the interconnect 30 may transmit data stored in the host memory 220 to the storage device 100 through the inner-path 120 of the CSD 10. For example, the interconnect 30 may transmit data stored in the storage device 100 to the host memory 220 through the inner-path 120.

An AI learning model, such as a large language model (LLM), has a very large amount of parameter data. The LLM may refer to a collection of natural language processing models with several hundreds of millions of parameters. Near-storage processing (NSP) may refer to technology in which a computing device around a storage performs computations based on data stored in the storage. The CSD 10 may be a type of NSP. Storage-offloaded training may refer to technology of storing data used for artificial neural network training in a storage.

Terms related to artificial neural network learning are explained below. Forwarding is a process of obtaining a predicted value of an artificial neural network by using input data and the parameters of the AI learning model. In this specification, a parameter of an AI learning model, a model parameter, a parameter, and a weight may be used interchangeably. The model parameter refers to a parameter learned in an artificial neural network. Activation refers to the artificial neural network's prediction value for the input data. Backwarding is a process of obtaining information needed to adjust the parameter so that the AI learning model better matches a correct answer of training data, by comparing the activation with the correct answer of training data. In other words, backwarding is a process of obtaining a gradient, and the gradient is information for training the AI learning model so that the AI learning model may perform better prediction. The gradient may be obtained by differentiating the difference between the predicted value and the correct answer. Updating is a process of adjusting the parameters of an artificial neural network through a mathematical algorithm using gradients and optimizer states (OSs). For example, algorithms, such as stochastic gradient descent (SGD) and Adam, may be used. OSs refer to information necessary for each algorithm in a process of adjusting parameters based on the gradient. During the updating process, adjusted (updated) parameters may be generated, and the OSs may also be updated. The AI learning model may be trained by repeating forwarding, backwarding, and updating.

The accelerator 110 may include a buffer memory 111, an updater 112, and a gradient decompressor 113. The updater 112 may include a plurality of processing elements (PEs). PEs may update target parameters in parallel. In some implementations, the buffer memory 111 may include, but is not limited to, dynamic random access memory (DRAM) and static RAM (SRAM).

The electronic device I may include the host 20, the interconnect 30, and the CSD 10. The host 20 may include the host memory 220, a first processor, and a second processor. The first processor may be the GPU 200, and the second processor may be the CPU 210. The first processor may update a gradient based on the parameter of the AI learning model stored in the host memory 220. The CSD 10 may include the storage device 100, the inner-path 120, and the accelerator 110. The storage device 100 may store gradients and OSs. The accelerator 110 may be configured to transmit and receive a gradient and an OS to and from the storage device 100 through the inner-path 120. For example, the storage device 100 may transmit at least one of the parameter, the gradient, and the OS to the accelerator 110 via direct peer-to-peer (P2P) communication. For example, the second processor may control the storage device 100 to transmit at least one of the parameter, the gradient, and the OS to the accelerator 110 via direct P2P communication. The interconnect 30 may connect the host 20 to the CSD 10 to achieve communication between the host 20 and the CSD 10 and may transmit the gradient and the parameter between the host 20 and the CSD 10. The second processor may control the accelerator 110 to update the OS and the parameter based on the gradient and the OS. For example, the second processor may control the updater 112 to update the OS and the parameter based on the gradient and the OS. The second processor may control the accelerator 110 to transmit the updated parameter to the host memory 220 through the inner-path 120 and the interconnect 30. The second processor may store the updated OS in the storage device 100 through the inner-path 120. The second processor may transmit the updated OS to the storage device 100 through direct P2P communication.

In some implementations, the storage device 100 may further store parameters. The accelerator 110 may include the buffer memory 111, and the buffer memory 111 may include subbuffer memories. The size of the subbuffer memories may correspond to the size of the largest subgroup among subgroups of parameters of the AI learning model. For example, the subgroups may include a first subgroup and a second subgroup. The subbuffer memories may include a first subbuffer memory. The second processor may control transmission of the first sub-group from the storage device 100 to the first subbuffer memory earlier than, e.g., before, a first OS associated with the first subgroup. The second processor may control the updater 112 to update the first subgroup earlier than the first OS. The second processor may control transmission of the updated first subgroup from the first sub-buffer memory to the storage device 100 earlier than the first OS. The second processor may control transmission of the updated first subgroup from the first subbuffer memory to the storage device 100 earlier than the first OS, and then transmit a second subgroup from the storage device 100 to the first subbuffer memory while transmitting the updated first OS from the first subbuffer memory to the storage device 100 in the same time interval. In other words, the transmission of the updated first OS from the first subbuffer memory to the storage device 100 and the transmission of the second subgroup from the storage device 100 to the first subbuffer memory may overlap each other in terms of time.

In some implementations, the first processor may compress the gradient and transmit the compressed gradient to the storage device 100 via the interconnect 30. The accelerator 110 may further include the gradient decompressor 113. The second processor may control the gradient decompressor 113 to receive the compressed gradient from the storage device 100 and decompress the compressed gradient. The AI learning model may include LLMs.

The electronic device I may reduce data traffic between the host 20 and the storage device 100 during a process of training the AI learning model. In detail, the updater 112 of the electronic device 1 may reduce a bottleneck phenomenon of the interconnect 30 by updating the OS based on the gradient and the OS and transmitting the updated OS to the storage device 100 through the inner-path 120.

The electronic device 1 may increase the number of CSDs 10 includable by the electronic device 1 by reducing the bottleneck of the interconnect 30.

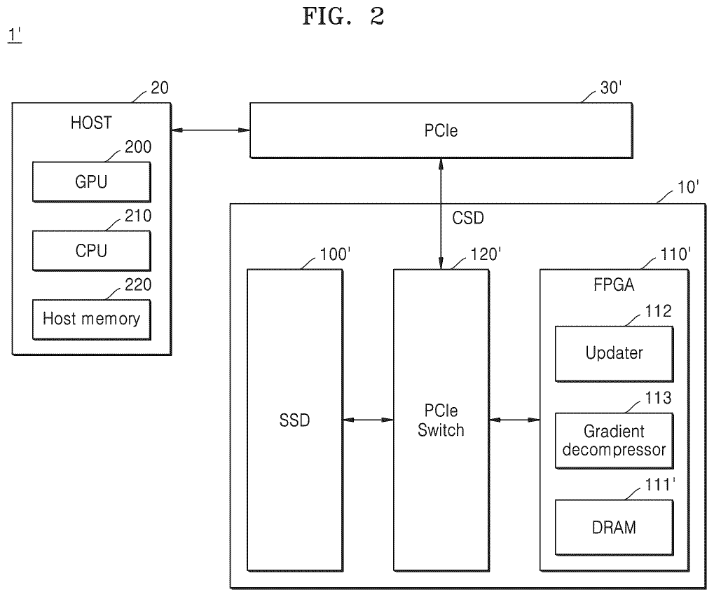

FIG. 2 is a block diagram of an example of an electronic device 1′.

FIG. 2 will now be described with reference to FIG. 1. The electronic device 1′ includes the host 20, a PCIe 30′, and a CSD 10′. The host 20 may include the host memory 220, the GPU 200, and the CPU 210. The GPU 200 may operate as an accelerator and may update a gradient based on the parameters of the AI learning model stored in the host memory 220.

The CSD 10′ may include an SSD 100′, a PCIe switch 120′, and an FPGA 110′. The SSD 100′ may store the parameters of the AI learning model, gradients, and OSs. The FPGA 110′ may be configured to transmit and receive a parameter, a gradient, and an OS to and from the SSD 100′ through the PCIe switch 120′. For example, the SSD 100′ may transmit at least one of the parameter, the gradient, and the OS to the FPGA 110′ via direct P2P communication. For example, the CPU 210 may control the SSD 100′ to transmit at least one of the parameter, the gradient, and the OS to the FPGA 110′ via direct P2P communication.

The interconnect 30 may connect the host 20 to the CSD 10 to achieve communication between the host 20 and the CSD 10′ and may transmit the gradient and the parameter between the host 20 and the CSD 10′. The CPU 210 may control the accelerator 110 to update the OS and the parameter based on the gradient and the OS. For example, the CPU 210 may control the updater 112 to update the OS and the parameter based on the gradient and the OS. The CPU 210 may control the accelerator 110 to transmit the updated parameter to the host memory 220 through the inner-path 120 and the interconnect 30. The CPU 210 may store the updated OS in the storage device 100 through the inner-path 120. The CPU 210 may transmit the updated OS to the storage device 100 through direct P2P communication.

In some implementations, the accelerator 110 may include the buffer memory 111, and the buffer memory 111 may include subbuffer memories. The size of the subbuffer memories may correspond to the size of the largest subgroup among subgroups of parameters of the AI learning model. For example, the subgroups may include a first subgroup and a second subgroup. The subbuffer memories may include a first subbuffer memory. The second processor may control transmission of the first sub-group from the storage device 100 to the first subbuffer memory earlier than a first OS associated with the first subgroup. The second processor may control the updater 112 to update the first subgroup earlier than the first OS. The second processor may control transmission of the first subgroup from the first subbuffer memory to the storage device 100 earlier than the first OS. The second processor may control transmission of the first subgroup from the first subbuffer memory to the storage device 100 earlier than the first OS, and then transmission of the second subgroup from the storage device 100 to the first subbuffer memory while transmitting the first OS from the first subbuffer memory to the storage device 100 in the same time interval. In other words, the transmission of the updated first OS from the first subbuffer memory to the storage device 100 and the transmission of the second subgroup from the storage device 100 to the first subbuffer memory may overlap each other in terms of time.

In some implementations, the GPU 200 may compress the gradient, and transmit the compressed gradient to the storage device 100 via the interconnect 30. The accelerator 110 may further include the gradient decompressor 113. The CPU 210 may control the gradient decompressor 113 to receive the compressed gradient from the storage device 100 and decompress the compressed gradient. The AI learning model may include LLMs.

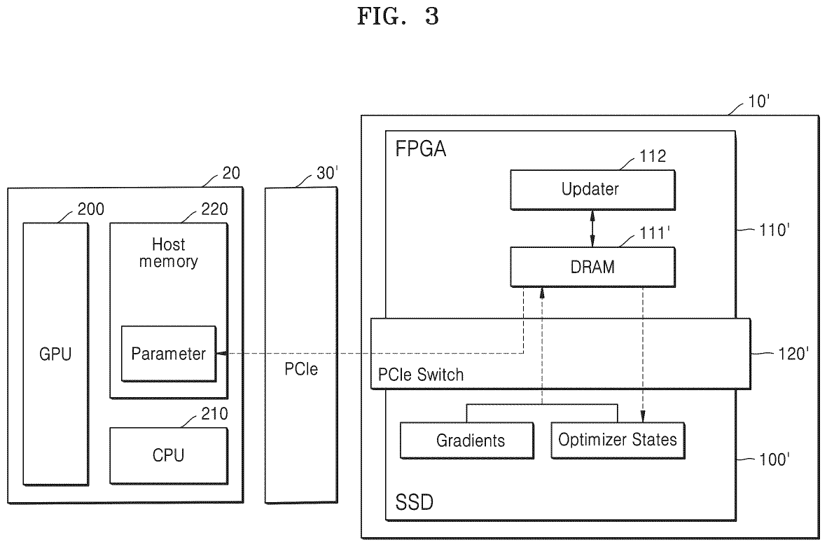

FIG. 3 is a block diagram to of an example of an update operation of an electronic device.

FIG. 3 may be explained with reference to FIG. 2, and any redundant explanation thereof may be omitted.

The electronic device 1′ may include the host 20, the PCIe 30′, and the CSD 10′. The host 20 may include the host memory 220, the GPU 200, and the CPU 210. The GPU 200 may operate as an accelerator and may update a gradient based on the parameter of the AI learning model stored in the host memory 220.

The CSD 10′ may include the SSD 100′, the PCIe switch 120′, and the FPGA 110′. The SSD 100′ may store gradients and OSs. The SSD 100′ may further store parameters of the AI learning model. The SSD 100′ may receive a gradient from the host 20 through the PCIe 30′ and the PCIe switch 120′ and store the received gradient. The CPU 210 may control the SSD 100′ to transmit a gradient and an OS to the DRAM 111′ of the FPGA 110′ through the PCIe switch 120′, based on direct P2P communication. The updater 112 of the FPGA 110′ may perform an update operation, based on the gradient and OS stored in the DRAM 111′. The updater 112 may update the OS and parameters by performing the update operation. The CPU 210 may control the FPGA 110′ to transmit the updated parameter to the host 20 through the PCIe 30′ and the PCIe switch 120′. The CPU 210 may control the host memory 220 to store the updated parameter. The CPU 210 may control the FPGA 110′ to transmit the updated OS to the SSD 100′through the PCIe switch 120′ and the SSD 100′to store the updated OS.

As described above, data necessary for updating an OS moves between the SSD 100′ and the FPGA 110′ within the CSD 10′. In contrast, data movement through the PCIe 30′ may include gradient write and parameter read on the side of the CSD 10′.

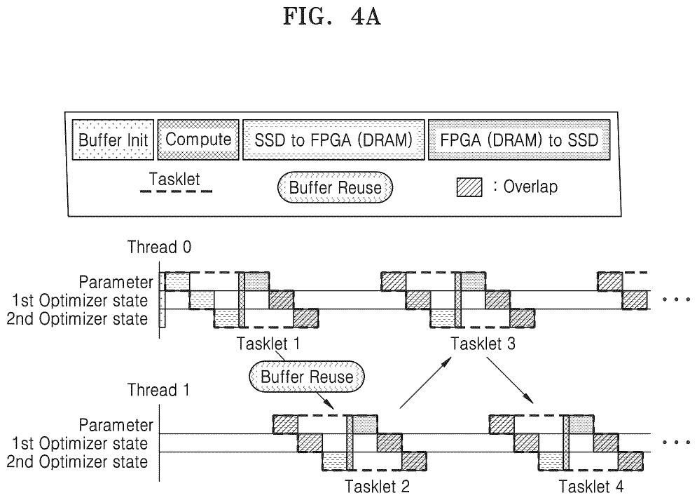

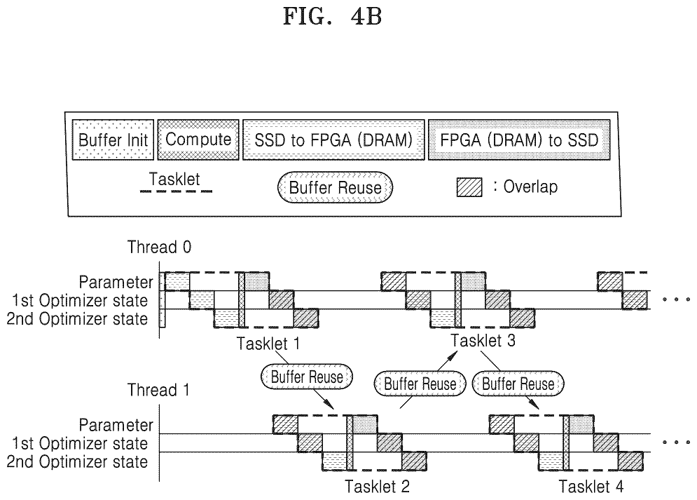

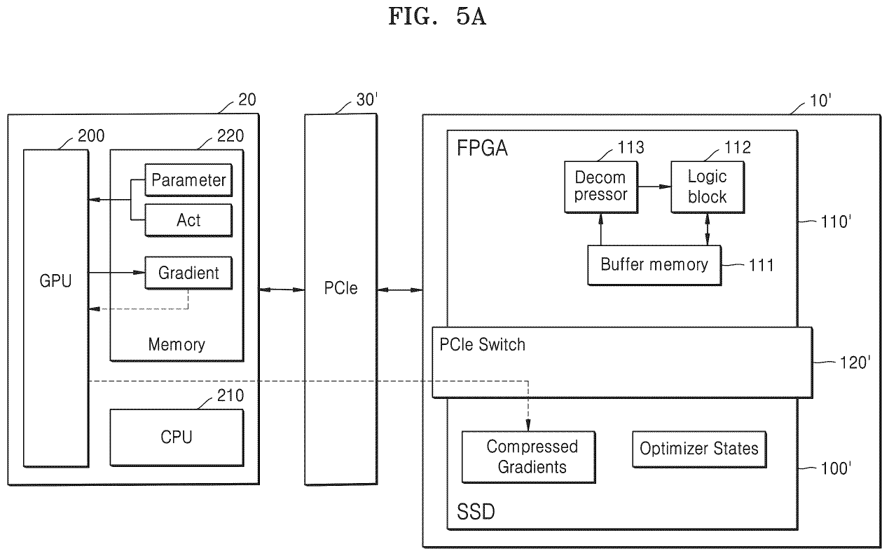

FIGS. 4A and 4B are diagrams of an example of data transmission of an electronic device.

FIGS. 4A and 4B may be explained with reference to FIG. 1 and FIG. 2. FIGS. 4A and 4B show timing of a data transmission operation within the CSD 10′.

In an iteration of storage-offloaded training, a model is split into multiple blocks, and one model is processed at a time. The number of parameters for each block may be determined based on expected memory requirements. For example, in an update operation, the size of subgroups of model parameters may be determined according to the memory capacity of the accelerator 110. Each subgroup may be processed in units of tasklets.

Referring to FIG. 4A, in some implementations, a first subgroup is processed in units of tasklet1, a second subgroup is processed in units of tasklet2, a third subgroup is processed in units of tasklet3, and a fourth subgroup is processed in units of tasklet4. A first OS and a second OS may be OSs associated with parameters. For example, when the electronic device 1′ uses an Adam algorithm, the first OS may be Momentum (Mnt) and the second OS may be Variance (VAR).

When the electronic device 1′ transmits and receives a parameter and an OS between the FPGA 110′ and the SSD 100′, the electronic device 1′ may transmit and receive more important data first. For example, data is more important if the data is associated with an operation that requires a large amount of computations during a training process of the AI learning model. More important data may include data necessary for a computation of the GPU 200. For example, a parameter may be more important data than an OS.

The buffer memory 111 (e.g., the DRAM 111′) may be pre-allocated in an initial stage of the update. For example, the DRAM 111′ may be divided and allocated into subbuffer memories, and the size of the subbuffer memories may correspond to the size of the largest subgroup among subgroups of the parameters.

To manage the allocated buffer memory 111, the CPU 210 may allocate two threads (thread0 and thread1). In tasklet1, a parameter is transmitted from the SSD 100′ to the FPGA 110′ earlier than the first OS and the second OS and is written from the FPGA 110′ to the SSD 100′ first. The parameter may be transmitted and received first because the parameter is used during performing forward and backward passes of the GPU 200. Because the first OS and the second OS may be used in an update stage of the iteration of next training, the first OS and the second OS may be transmitted and received later than the parameter. Thread 0 may postpone writeback of the first OS and the second OS and may transmit and receive a signal for starting loading the parameter of a next subgroup to and from thread 1. Accordingly, the transmission of the first OS and the second OS from the FPGA 110′ to the SSD 100′ in tasklet 1 may be performed simultaneously with the transmission of the parameter and the first OS from the SSD 100′ to the FPGA 110′ in tasklet 2. Because the size of the subbuffer memory is allocated to correspond to the size of the largest subgroup among the subgroups of parameters, thread 1 may re-use the same subbuffer memory as thread 0. Accordingly, reallocation of the buffer memory 111 may be avoided, the GPU 200 may perform forward and backward steps earlier, and data transfer may be overlapped in the same subbuffer memory.

FIG. 4A shows a case where tasklet 1 and tasklet 2 are allocated the same sub-buffer memory. Accordingly, when data transmission and reception of tasklet 1 overlaps data transmission and reception of tasklet 2, data transmission and reception may be performed in the same subbuffer memory.

FIG. 4B shows a case where tasklet 1, tasklet 2, and tasklet 3 are allocated the same subbuffer memory. Accordingly, the same subbuffer memory may be sequentially re-used for tasklet1, tasklet2, tasklet3, and tasklet4.

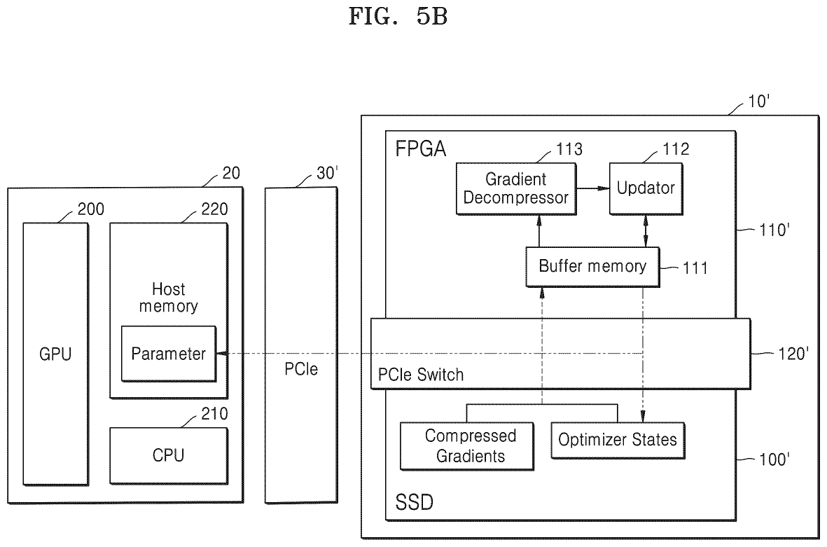

FIGS. 5A and 5B are block diagrams of examples of a gradient decompression operation of an electronic device.

FIGS. 5A and 5B will now be described in conjunction with FIGS. 1 and 2.

FIG. 5A shows a process, performed by the host 20, of compressing a gradient and transmitting the compressed gradient to the CSD 10′. Referring to FIG. 5A, the GPU 200 may generate a gradient by using a parameter of the AI learning model and activation in a backward step. The GPU 200 may store the generated gradient in the host memory 220. The GPU 200 may store the gradient in the SSD 100′ via the PCIe 30′ and the PCIe switch 120′ to offload the gradient stored in the host memory 220 to the SSD 100′. The GPU 200 may compress gradients and store the compressed gradients in the SSD 100′ through the PCIe 30′ and the PCIe switch 120′. For example, the GPU 200 may compress the gradients by using a TOP-k algorithm.

In some implementations, when the number of SSDs connected via the PCIe 30′ is equal to or greater than a certain number, the host 20 may compress the gradients and offload the compressed gradients to the SSDs. In some implementations, the host 20 may compress the gradients to increase an offload speed, and offload the compressed gradients to the SSD 100′.

FIG. 5B shows an operation, performed by the CSD 10′, of decompressing the compressed gradients. Referring to FIG. 5B, the FPGA 110′ may include the updater 112, the gradient decompressor 113, and the buffer memory 111. The host 20 may control the gradient decompressor 113 to receive the compressed gradients from the SSD 100′ and decompress the compressed gradients. For example, the CPU 210 may control the gradient decompressor 113 to receive the compressed gradients from the SSD 100′ and decompress the compressed gradients. The FPGA 110′ may read the compressed gradients stored in the SSD 100′ through the PCIe switch 120′ and store the read-out compressed gradients in the buffer memory 111. The gradient decompressor 113 may receive the compressed gradients from the buffer memory 111 and decompress the compressed gradients. The updater 112 may perform an update operation based on the decompressed gradients.

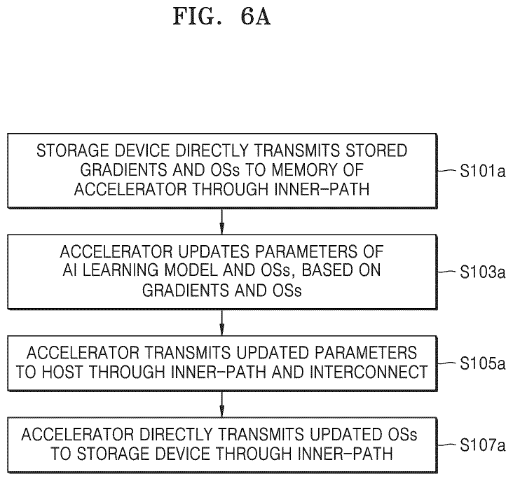

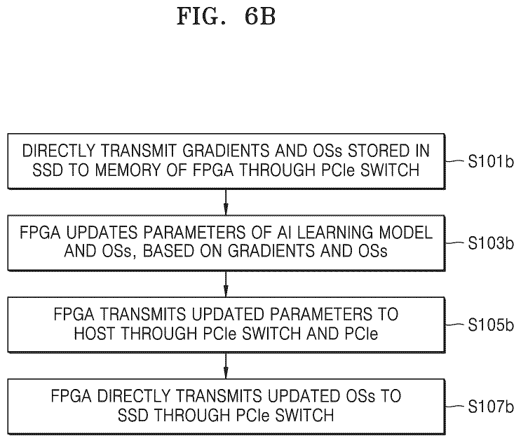

FIG. 6A is a flowchart of an example of an update operation of an electronic device. FIG. 6A will now be described in conjunction with FIG. 1.

In operation S101a, the storage device 100 directly transmits stored gradients and OSs to the buffer memory 111 of the accelerator 110 through the inner-path 120.

In operation S103a the accelerator 110 may update the parameters of the AI learning model and OSs, based on gradients and OSs.

In operation S105a, the accelerator 110 may transmit the updated parameters to the host 20 through the inner-path 120 and the interconnect 30.

In operation S107a, the accelerator 110 may directly transmit the updated OSs to the storage device 100 through the inner-path 120.

The electronic device 1 may perform training of the AI learning model by repeating the above-described forward, backward, and update operations.

FIG. 6B is a flowchart of an example of an update operation of an electronic device.

FIG. 6B will now be described in conjunction with FIG. 2.

In operation S101b, the SSD 100′ may directly transmit the gradients and OSs stored in the SSD 100′ to the buffer memory 111 of the FPGA 110′ through the PCIe switch 120′.

In operation S103b, the FPGA 110′ may update the parameters of the AI learning model and OSs, based on the gradients and the OSs.

In operation S105b, the FPGA 110′ may transmit the updated parameters to the host 20 through the inner-path 120 and the PCIe 30′.

In operation S107b, the FPGA 110′ may directly transmit the updated OSs to the SSD 100′ through the inner-path 120.

The electronic device 1′ may perform training of the AI learning model by repeating the above-described forward, backward, and update operations.

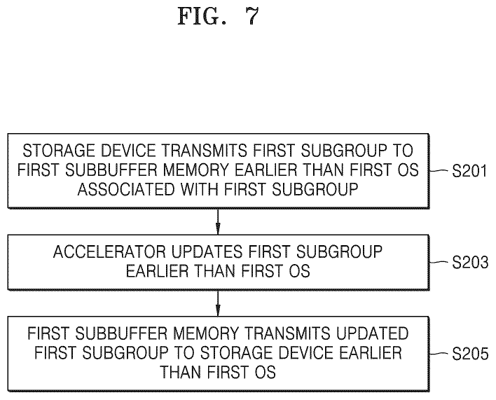

FIG. 7 is a flowchart of an example of a data transmission operation of an electronic device.

FIG. 7 will now be described in conjunction with FIG. 1.

The buffer memory 111 may include subbuffer memories, and the size of the subbuffer memories may correspond to the size of the largest subgroup among subgroups of the parameters. The subgroups may include a first subgroup and a second subgroup, and the subbuffer memories may include a first subbuffer memory. The first processor may update a gradient based on the parameter of the AI learning model stored in the host memory 220.

In operation S201, the storage device 100 may transmit the first subgroup to the first subbuffer memory earlier than the first OS associated with the first subgroup. For example, the second processor may control transmission of the first subgroup from the storage device 100 to the first subbuffer memory earlier than the first OS associated with the first subgroup.

In operation S203, the accelerator 110 may update the first subgroup earlier than the first OS. For example, the second processor may control the accelerator 110 to update the first subgroup earlier than the first OS.

In operation S205, the first subbuffer memory may transmit the updated first sub-group to the storage device 100 earlier than the first OS. The second processor may control transmission of the updated first subgroup from the first subbuffer memory to the storage device 100 earlier than the first OS.

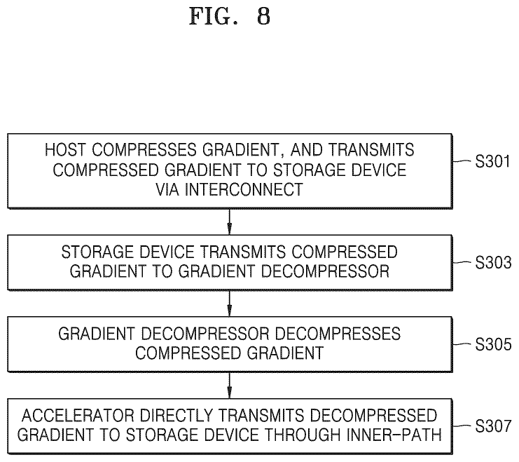

FIG. 8 is a flowchart of an example of a gradient decompression operation of an electronic device.

FIG. 8 will now be described in conjunction with FIG. 1.

In operation S301, the host 20 may compress a gradient, and transmit the compressed gradient to the storage device 100 via the interconnect 30.

In operation S303, the storage device 100 may transmit the compressed gradient to the gradient decompressor 113.

In operation S305, the gradient decompressor 113 may decompress the compressed gradient.

In operation S307, the accelerator 110 may directly transmit the decompressed gradient to the storage device 100 through the inner-path 120.

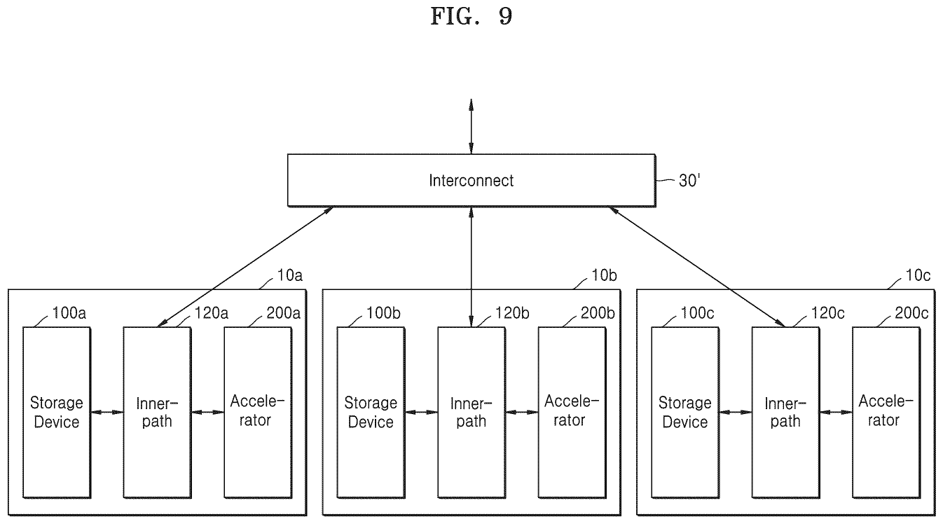

FIG. 9 is a block diagram of an example of a RAID structure.

FIG. 9 may be described in conjunction with FIG. 1. FIG. 9 shows a CSD system in which a plurality of CSDs 10a, 10b, and 10c are connected to the host 20 through the interconnect 30′. The storage device 100 may support a Redundant Array of Inexpensive Disk (RAID) and may secure the stability of data by using various methods according to RAID levels.

The plurality of CSDs 10a, 10b, and 10c may include storage devices 100a, 100b, and 100c, inner-paths 120a, 120b, and 120c, and accelerators 200a, 200b, and 200c, respectively. The plurality of CSDs 10a, 10b, and 10c may communicate with the host 20 through a single interconnect 30.

The electronic device 1 may include the host memory 220, the first processor, and the second processor. The first processor may update the gradient, based on the parameters stored in the host memory. The plurality of CSDs 10a, 10b, and 10c may include storage devices 100a, 100b, and 100c storing parameters of the AI learning model, gradients, and OSs, and accelerators 200a, 200b, and 200c configured to transmit and receive the parameters, the gradients, and the OSs to and from the storage devices 100a, 100b, and 100c through inner-paths 120a, 120b, and 120c, respectively.

The electronic device 1 may include an interconnect that connects the host 20 to the plurality of CSDs 10a, 10b, and 10c and transmits the gradients and the parameters between the host 20 and the plurality of CSDs 10a, 10b, and 10c. The second processor may control each of the accelerators 200a, 200b, and 200c to update the OSs and the parameters based on the gradients and the OSs.

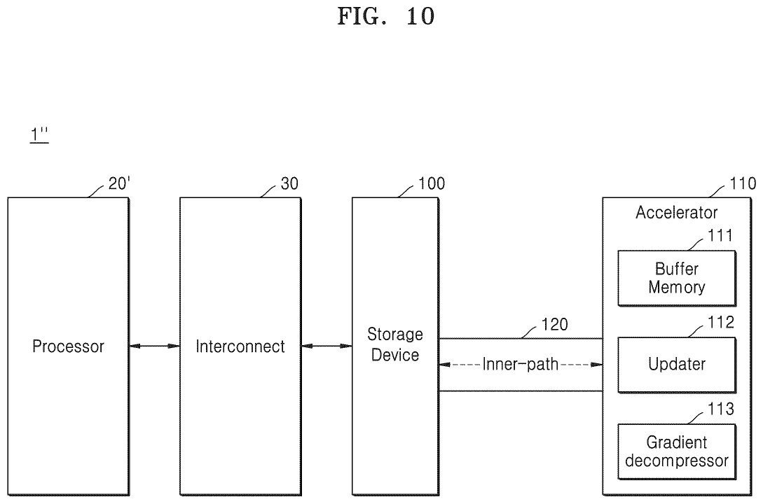

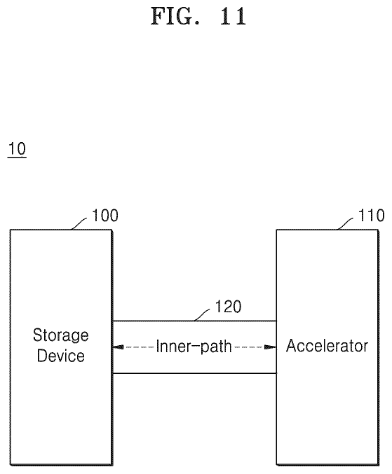

FIG. 10 is a block diagram of an example of an electronic device 1″.

FIG. 10 may be described in conjunction with FIG. 1. The electronic device 1″ may include a processor 20′ that updates gradients based on parameters of an AI learning model, the storage device 100 storing gradients and OSs, the inner-path 120 that performs direct communication between the storage device 100 and the accelerator 110, and the accelerator 110 configured to transmit and receive the gradients and the OSs to and from the storage device 100 through the inner-path 120. The electronic device 1″ may include the interconnect 30 that performs communication between the processor 20′ and the storage device 100 and transmits the parameters of the AI learning model and the gradients between the processor 20′ and the storage device 100. The processor 20′ may control the accelerator 110 to update the OSs and the parameters based on the gradients and the OSs. The processor 20′ may control storing of the updated OSs in the storage device 100 through the inner-path 120.

The accelerator 110 may include the buffer memory 111, the updater 112, and the gradient decompressor 113, and may operate as described above with reference to FIG. 1.

FIG. 11 is a block diagram of the CSD 10.

FIG. 11 may be described in conjunction with FIG. 1. The CSD 10 may include the storage device 100 storing gradients and OSs that are to be updated based on the parameters of the AI learning model, the inner-path 120 that performs direct communication between the storage device 100 and the accelerator 110, and the accelerator 110 configured to transmit and receive the gradients and the OSs to and from the storage device 100 through the inner-path 120 and update the OSs and the parameters, based on the gradients and the OSs. The AI learning model includes an LLM.

In some implementations, the accelerator 110 may transmit the updated OSs to the storage device 100 via the inner-path 120.

In some implementations, the accelerator 110 may store the updated OSs to the storage device 100 via the inner-path 120.

In some implementations, the storage device 100 may be an SSD, the accelerator 110 may be an FPGA, the interconnect 30 may be a PCIe, and the inner-path 120 may be a PCIe switch. Alternatively, the interconnect 30 may be a CXL, and the inner-path 120 may be a CXL switch.

In some implementations, the storage device 100 may store parameters, the accelerator 110 may include a buffer memory, and the buffer memory may include subbuffer memories. The size of the subbuffer memories may correspond to the size of the largest subgroup among subgroups of the parameters. The subgroups may include a first subgroup and a second subgroup, and the subbuffer memories may include a first subbuffer memory. The first subgroup may be transmitted from the storage device 100 to the first subbuffer memory earlier than the first OS associated with the first subgroup. The accelerator 110 may update the first subgroup earlier than the first OS. The updated first subgroup may be transmitted from the first subbuffer memory to the storage device 100 earlier than the first OS.

In some implementations, the first subgroup may be transmitted from the first subbuffer memory to the storage device 100 earlier than the first OS, and then, in the same time interval, the first OS may be transmitted from the first subbuffer memory to the storage device 100 and the second subgroup may be from the storage device 100 to the first subbuffer memory.

In some implementations, the storage device 100 may receive a compressed gradient from an external device. The accelerator 110 may further include a gradient decompressor. The gradient decompressor may receive the compressed gradient from the storage device 100 and decompress the compressed gradient.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The inventive concept has been particularly shown and described with reference to exemplary embodiments thereof. While the inventive concept has been particularly shown and described with reference to embodiments thereof, it will be understood that various changes in form and details may be made therein without departing from the spirit and scope of the following claims.

What is claimed is:

1. An electronic device comprising:
a host comprising a host memory, a first processor, and a second processor, wherein the first processor is configured to update gradients based on parameters of an artificial intelligence (AI) learning model stored in the host memory;
a computational storage device (CSD) including a storage device configured to store the gradients and optimizer states (OSs) and an accelerator configured to transmit and receive the gradients and the OSs to and from the storage device through an inner-path; and
an interconnect configured to connect the host to the CSD and transmit the parameters of the AI learning model and the gradients between the host and the CSD,
wherein the second processor is configured to control the accelerator to update the OSs and the parameters based on the gradients and the OSs.

2. The electronic device of claim 1, wherein the second processor is configured to control the accelerator to transmit the updated parameters to the host memory via the inner-path and the interconnect.

3. The electronic device of claim 1, wherein the second processor is configured to control storage of the updated OSs in the storage device via the inner-path.

4. The electronic device of claim 1, wherein the storage device includes a solid state drive (SSD),
wherein the accelerator includes a Field Programmable Gate Array (FPGA),
wherein the interconnect includes Peripheral Component Interconnect Express (PCIe), and
wherein the inner-path includes a PCIe switch.

5. The electronic device of claim 1, wherein the storage device is configured to stored the parameters,
wherein the accelerator includes a buffer memory,
wherein the buffer memory includes subbuffer memories,
wherein a size of the subbuffer memories corresponds to a size of a largest subgroup among subgroups of the parameters,
wherein the subgroups include a first subgroup and a second subgroup,
wherein the subbuffer memories include a first subbuffer memory, and
wherein the processor is configured to control transmission of the first subgroup from the storage device to the first subbuffer memory earlier than a first OS associated with the first subgroup, and is configured to control the accelerator to update the first subgroup earlier than the first OS, and
wherein the processor is configured to control transmission of the updated first subgroup from the first subbuffer memory to the storage device earlier than the updated first OS.

6. The electronic device of claim 5, wherein the second processor controls transmission of the first subgroup from the first subbuffer memory to the storage device earlier than the first OS and then transmission of the second subgroup from the storage device to the first subbuffer memory while transmitting the first OS from the first subbuffer memory to the storage device in the same time interval.

7. The electronic device of claim 1, wherein the first processor includes a graphics processing unit (GPU), and
wherein the second processor includes a central processing unit (CPU).

8. The electronic device of claim 1, wherein the first processor is configured to compress the gradients and to transmit the compressed gradients to the storage device through the interconnect,
wherein the accelerator further includes a gradient decompressor, and
wherein the second processor is configured to control the gradient decompressor to receive the compressed gradients from the storage device and decompress the compressed gradients.

9. The electronic device of claim 1, wherein the AI learning model includes large language models (LLMs).

10. An electronic device comprising:
a host comprising a host memory, a first processor, and a second processor, wherein the first processor is configured to update gradients, based on parameters stored in the host memory;
a plurality of computational storage devices (CSDs) including a storage device configured to store parameters of an artificial intelligence (AI) learning model, the gradients, and optimizer states (OSs) and an accelerator configured to transmit and receive the parameters, the gradients, and the OSs to and from the storage device through an inner-path; and
an interconnect configured to connect the host to the plurality of CSDs and to transmit the gradients and the parameters between the host and the plurality of CSDs,
wherein the second processor is configured to control the accelerator to update the OSs and the parameters based on the gradients and the OSs.

11. The electronic device of claim 10, wherein the second processor is configured to control the accelerator to transmit the parameters to the host memory via the inner-path and the interconnect.

12. The electronic device of claim 10, wherein the second processor is configured to control storage of the updated OSs in the storage device via the inner-path.

13. The electronic device of claim 10, wherein the storage device is a solid state drive (SSD),
wherein the accelerator is a Field Programmable Gate Array (FPGA),
wherein the interconnect is Peripheral Component Interconnect Express (PCIe), and
wherein the inner-path is a PCIe switch.

14. The electronic device of claim 10, wherein the accelerator includes a buffer memory,
wherein the buffer memory includes subbuffer memories,
wherein a size of the subbuffer memories corresponds to a size of a largest subgroup among subgroups of the parameters,
wherein the subgroups include a first subgroup and a second subgroup,
wherein the subbuffer memories include a first subbuffer memory, and
wherein the second processor is configured to control transmission of the first subgroup from the storage device to the first subbuffer memory earlier than a first OS associated with the first subgroup,
wherein the second processor is configured to control the accelerator to update the first subgroup earlier than the first OS, and
wherein the second processor is configured to control transmission of the updated first subgroup from the first subbuffer memory to the storage device earlier than the first OS.

15. The electronic device of claim 14, wherein the second processor controls transmission of the first subgroup from the first subbuffer memory to the storage device earlier than the first OS and then transmission of the second subgroup from the storage device to the first subbuffer memory while transmitting the first OS from the first subbuffer memory to the storage device in the same time interval.

16. The electronic device of claim 10, wherein the first processor is a graphics processing unit (GPU), and
wherein the second processor is a central processing unit (CPU).

17. The electronic device of claim 9, wherein the first processor is configured to compress the gradients and transmit the compressed gradients to the storage device through the interconnect,
wherein the accelerator further includes a gradient decompressor, and
wherein the second processor is configured to control the gradient decompressor to receive the compressed gradients from the storage device and decompress the compressed gradients.

18. The electronic device of claim 9, wherein the AI learning model includes large language models (LLMs).

19. A computational storage device (CSD) comprising:
a storage device storing gradients and optimizer states (OSs) that are configured to be updated based on parameters of an artificial intelligence (AI) learning model;
an inner-path configured to perform direct communication between the storage device and an accelerator; and
an accelerator configured to transmit and receive the gradients and the OSs to and from the storage device through the inner path and update the OSs and the parameters based on the gradients and the OSs.

20. The CSD of claim 19, wherein the accelerator transmits the updated OSs to the storage device via the inner-path.
